(19) United States
(12) Patent Application Publication
(10) Pub. No.: US 2005/0056728 A1
(43) Pub. Date: Mar. 17, 2005

(54) Kite

(76) Inventor: Paul Daniel Louis Barnes, Auckland (NZ)

Correspondence Address: LAW OFFICES OF;JACOBSON HOLMAN, PROFESSIONAL LIMITED LIABILITY COMPANY, 400 SEVENTH STREET, N. W., WASHINGTON, DC, 20004, US

(21) Appl. No.: 10/895,415

(22) Filed: Jul. 21, 2004

(30) Foreign Application Priority Data
Jul. 21, 2003 (NZ) 527120
Jul. 30, 2003 (NZ) 527312

(51) Int. Cl. B64C 31/06

(52) U.S. Cl. 244/153 R

(57) ABSTRACT

A steerable single or multi-compartment, sled-shaped, inflatable kite having a pair or series of substantially longitudinal gas chambers as beams, which kite, when inflated, is generally in the form of a tapered rectangle with a triangular keel attached to each outside gas chambers (and optionally attached to each of any inside gas chambers), there being a non-inflatable area between the longitudinal gas chambers that provides sail area and/or additional sail area.

### TECHNICAL FIELD

The present invention relates to a kite and to related uses and methods.

Kites of many forms are known. Quite apart from those that are used for mere pleasure, aerobatics or the like there are those kites that serve a useful function. Included in these later kinds of kites are those that might be used to carry or tow a fishing line offshore and those that might carry a camera aloft.

### BACKGROUND

The present invention is directed to a kite for whatsoever purpose it might be employed but preferably to a kite of a kind that has a capability of being used to tow and carry or tow and support a fishing line and/or carry other items aloft.

The present invention is related to a novel kite form having a number of capabilities including an ability in its preferred form of being capable of being launched from the water, collapsing without damage in excessive wind conditions, reforming when the wind drops below an excessive wind condition and/or being towed on water without acting as a sea anchor, (i.e. will collapse should it dive but reform and/or float subsequently).

### BRIEF DESCRIPTION OF THE INVENTION

In one aspect the present invention consists in a kite having or including one or more membrane type panel(s) alone or collectively defining at least substantially all of the leading edge, trailing edge and the lateral expanse of the kite,
at least a keel from at or adjacent each lateral extremity, such a keel form being (directly or indirectly) each attachable to or attached to a control line or a bridle connecting or connectable to a control line, and
a fore and aft extending inflated or inflatable beam at or adjacent each lateral extremity and/or each keel form at or adjacent the lateral extremity.

Preferably each keel form is substantially in the form of a membrane so as to confine wind between the peripheral keels and the panel or panels.

Whilst in a preferred form the inflated or inflatable beams are preferably tubular and can be of any inflated cross-section, they can, if desired, taper or otherwise vary in cross-section along their length fore and aft. For example, the beam(s) could on inflation assume along its length an overall airfoil shape to assist lift.

Preferably the inflated or inflatable beams extend beyond the leading edge and/or trailing edge. However such beams can also be flush with the leading and/or trailing edges.

The general longitudinal axis of each inflated beam is parallel to or angled acutely with respect to a central axis of the kite.

This angle is preferably from 0 to 15 degrees (inclusive) with the beam to beam spacing being greater at the leading edge than at the trailing edge. A greater angling is preferably associated with a cross-sectional tapering of the beam(s).

Preferably the general longitudinal axis of each of said inflated or inflatable beams is such that there is an angling relative to a central axis of the kite or angling mutually with respect to each other.

Preferably said angling with respect to a central axis is less than 5 degrees and has the effect of providing a greater leading edge than trailing edge.

Preferably the taper is in the range of from 1 degree to 5 degrees with respect to a central axis (e.g. most preferably between 2.5 to 3 degrees).

A feature of a kite of the present invention is the lack of any substantial restriction in movement together of the spaced apart inflated or inflatable beams, i.e. unlike arrangements as, for example, in U.S. Pat. No. 5,816,537 (with its inflated trailing edge) or German Patent Specification DE3523918 (with its generally ‘M’ shaped complex inflated support of the kite membrane).

Optionally one or more additional inflated or inflatable beams can be provided that extend in or generally in a fore and aft direction. Any such additional inflated booms can optionally be adjacent to an additional keel or other control line attachment apparatus.

In another aspect the invention is a steerable single or multi-compartment, sled-shaped, inflatable kite having a pair or series of substantially longitudinal gas chambers as beams, which kite, when inflated, is generally in the form of a tapered rectangle with a triangular keel attached to each outside gas chambers (and optionally attached to each of any inside gas chambers), there being a non-inflatable area between the longitudinal gas chambers that provides sail area and/or additional sail area.

Preferably the two or the two outermost gas beams are set so that they are angled apart with the widest point at the top of the kite.

Preferably each keel has one or more line anchor points.

Preferably a bridle with as many lines as the kite has keels is tied to a common point sufficiently distant from the kite as to allow the kite to open correctly. The bridle legs are connected to each keel at an anchor point corresponding to same position as the other two.

The kite can have a minimum of two longitudinal gas beams and keels up to an unlimited number of longitudinal gas beams and/or keels. Only the two outside longitudinal gas beams have to have keels for the kite to fly, although the kite is less likely to collapse in flight if additional keels are added to the or any inside longitudinal gas beams.

Steering or tacking the kite may be achieved by shortening one of the outside bridle legs, putting a kite tail or drogue on one side or other of the kite, or both.

In another aspect the invention is a tackable (steerable) single or multi-compartment, sled-shaped, inflatable kite having, when inflated, a series of longitudinal gas beams, each of which is attached to a keel.

Preferably a two outside gas beams are set so that they are angled apart with the widest point at the top of the kite.

Preferably each keel has one or more in line anchor points.

A bridle preferably with as many lines as the kite has keels is preferably tied to a common point sufficiently distant from the kite as to allow the kite to open correctly, on a three keeled version one bridle leg is attached to the central keel and one on each of the side gas beams.

The bridle legs are connected to each keel at an anchor point corresponding to the same position on each keel.

The kite can have a minimum of two longitudinal gas beams and keels up to an unlimited number of longitudinal gas beams and keels. Only the two outside longitudinal gas beams have to have keels for the kite to fly, although the kite is less likely to collapse in flight if additional keels are added to the inside longitudinal gas beams.

The kite beams can be filled with air or lighter than air gasses. The diameter of the longitudinal gas beams can be increased to allow for sufficient gas to overcome the weight of the kite and kiteline and provide a small amount of lift even when the wind is calm.

The kite can be made from cloth with separate bladders which are inserted into pockets or the kite can be made entirely from lightweight airtight materials and heat welded or glued together.

Whilst reference is made to longitudinally extending inflated or inflatable beams it should be appreciated any number of inflation chambers may be used for each. In each case, preferably there is only one.

The present invention also involves the use of a kite as previously defined for any purpose, recreation or otherwise, e.g. including fishing or load lifting, signalling or the like.

In yet a further aspect the present invention consists in a kite as aforesaid when incomplete insofar as inflatable bladders (if any) are concerned.

In yet a further aspect the present invention consists in a kite as aforesaid in combination with a bridle, control line or lines and/or any optional tail feature.

### BRIEF DESCRIPTION OF THE DRAWINGS

Preferred forms of the present invention will now be described with reference to the accompanying drawings in which

FIG. 1 shows inflated, and flying, a three keeled and three inflated beam kite in accordance with the present invention, the outer two beams from which each outer keel depends being angled one relative to the other so as to provide a greater leading edge than there is a trailing edge,

FIG. 2 shows a similar form of kite to that of FIG. 1 but one having only the two spaced apart and mutually angled inflatable outside beams,

FIG. 3 shows the kite as shown in FIG. 1 when laid out flat but with the beams all inflated but with the keels laid down to reveal their preferred triangular form with a bridle line attachment region in advance of the middle of the kite when considered in the fore and aft condition,

FIG. 4 is a similar view to that of FIG. 3 but in respect of the kite of FIG. 2,

FIG. 5 shows an alternative to the arrangement of FIG. 3, such as might be the case where sleeves are provided, e.g. as pockets into which a bladder is inserted,

FIG. 6 is a similar view to that of FIG. 5 but in respect of a variation of the kite shown in FIG. 4,

FIG. 7 shows detail of the lower most end of the beam shown in FIG. 5,

FIG. 8 shows a preferred alternate keel to the forms shown in the other figures thereby allowing some alteration of the fore and aft attachment of the attachment lines,

FIG. 9 shows a sequence from a flat tube and a flat tube valve to final assembly reliant upon heat sealing or gluing which leaves a valved tube of a lie flat type inserted through the aft end of the structure shown in FIG. 5 or 6,

FIG. 10A to 10G show inflated beam sections and their relativity to a membrane that defines the panels and outer keels of a kite having 3 beams, and

FIG. 11 shows for a three keel and three beamed kit how it looks with each beam tapering off to the rear.

### DETAILED DESCRIPTION OF THE INVENTION

In the preferred form of the present invention there is provided keels 1 and 2 each preferably as an extension of the membrane panel 10 and having attached thereto by stitching, adhesion, heat welding or the like the inflatable beam, boom, strut or the like framing structures 3 and 4 (“beams”) respectively. Whilst each beam preferably assumes an angle of 0 to 15 degrees with respect to a central longitudinal axis of the kite, the leading edge being at least as great as the trailing edge, as depicted in, for example FIG. 4, each outer boom defines a convergence that is between 2½ and 3 degrees with respect to the centre line of the kite thereby presenting a greater leading edge 5 when compared to the trailing edge 6 (i.e. the fore and aft edges respectively).

Bridal attachment islets 7 and 8 are provided on the keels 1 and 2 respectively. Other attachments can be positioned across the trailing edge region of the panel 10 at any of the positions allowed by the islet row 9 thereby allowing a tail or drogue to be attached as is appropriate to allow performance (e.g. tacking) in differently angled wind conditions.

Alternative arrangements as depicted in FIG. 8 can be utilised for the keels, whether keel forms in substitution for those 1 and 2 of the embodiment of FIG. 4 or for the middle or other keels that might be provided on a more expansively dimensioned kite than the three boom form depicted.

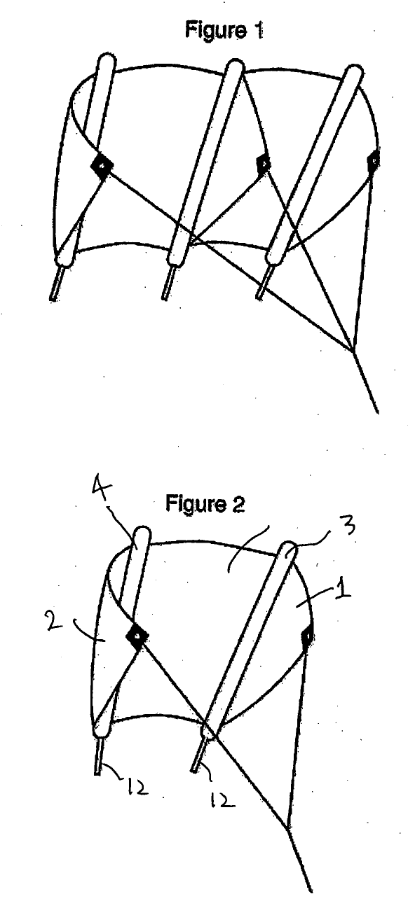

Persons skilled in the art will appreciate the desirability of confining the captured air to provide pressure between the peripheral keels 1 and 2 or 1A and 2A so as to keep the panel 10, or 10A and 10B as shown in FIGS. 2 and 1 respectively.

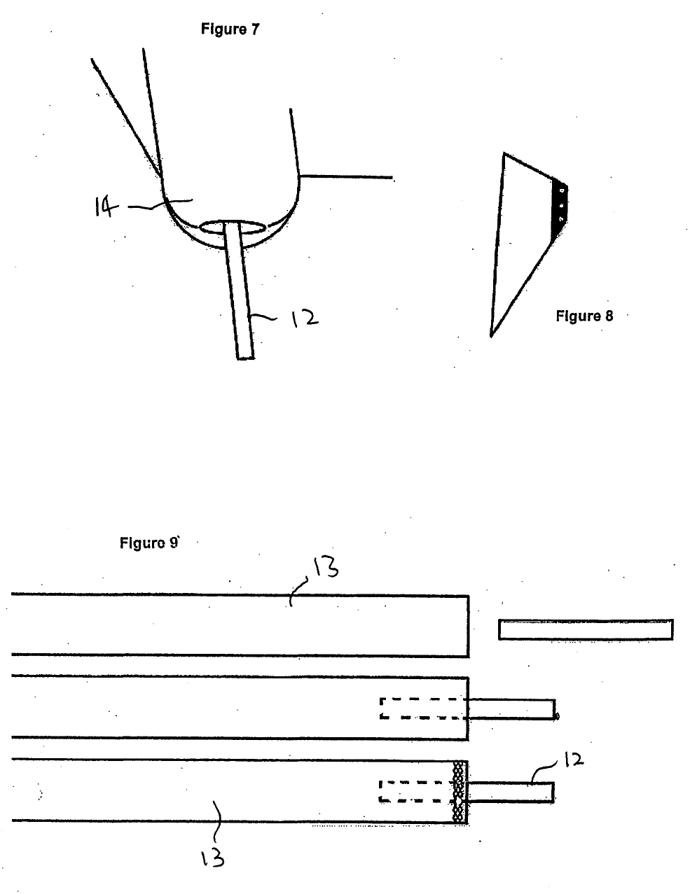

FIG. 7 shows a lie flat valve 12 in an outer bladder 13 for positioning in a sleeve 14 or for providing a beam 3 or 4 itself.

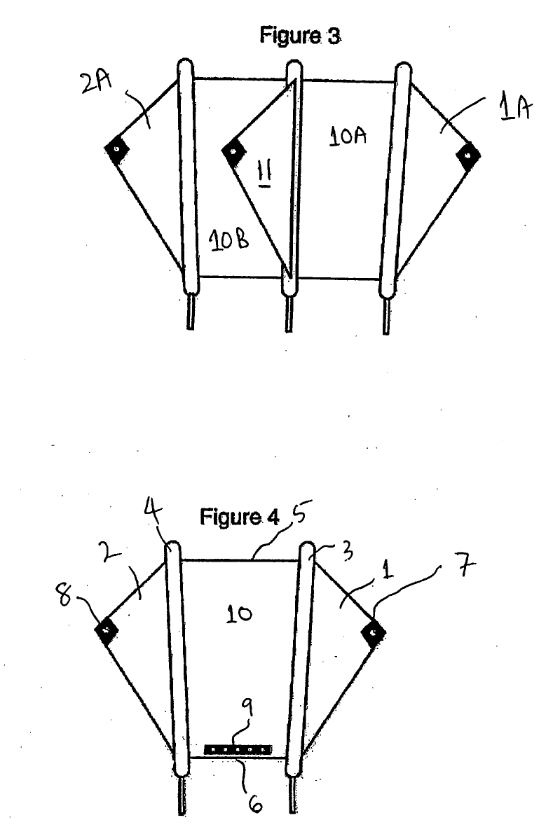

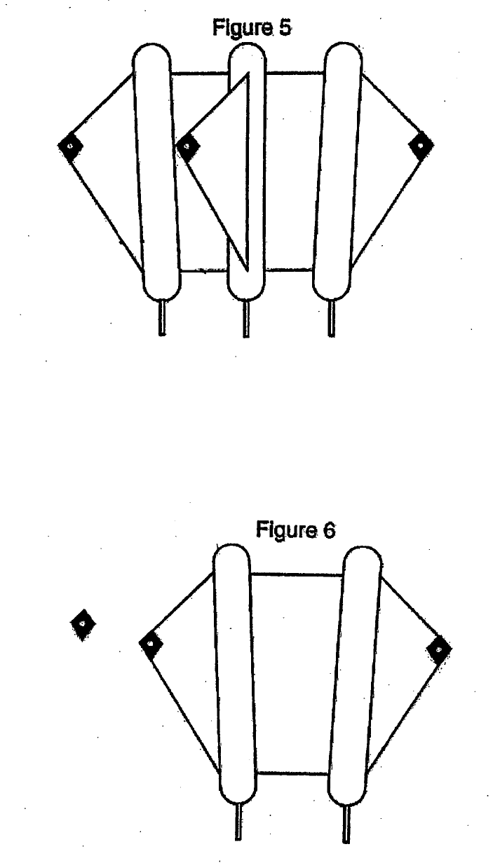

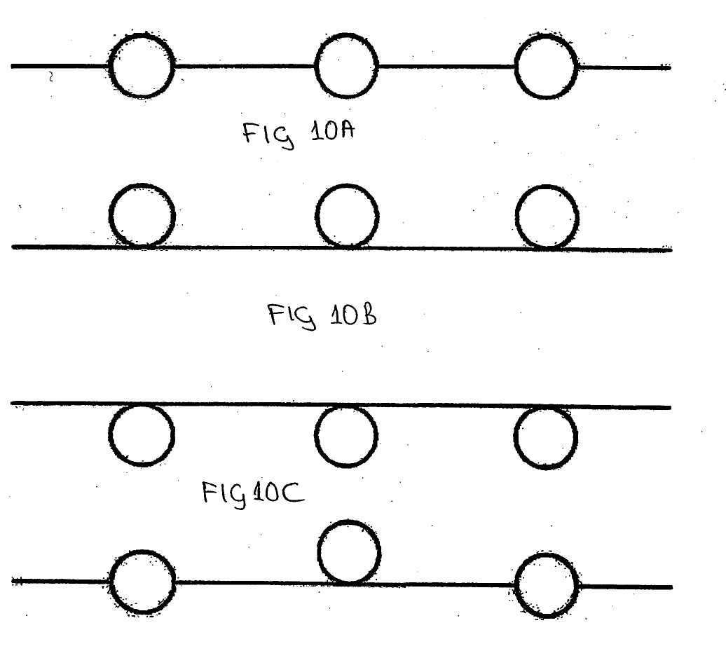

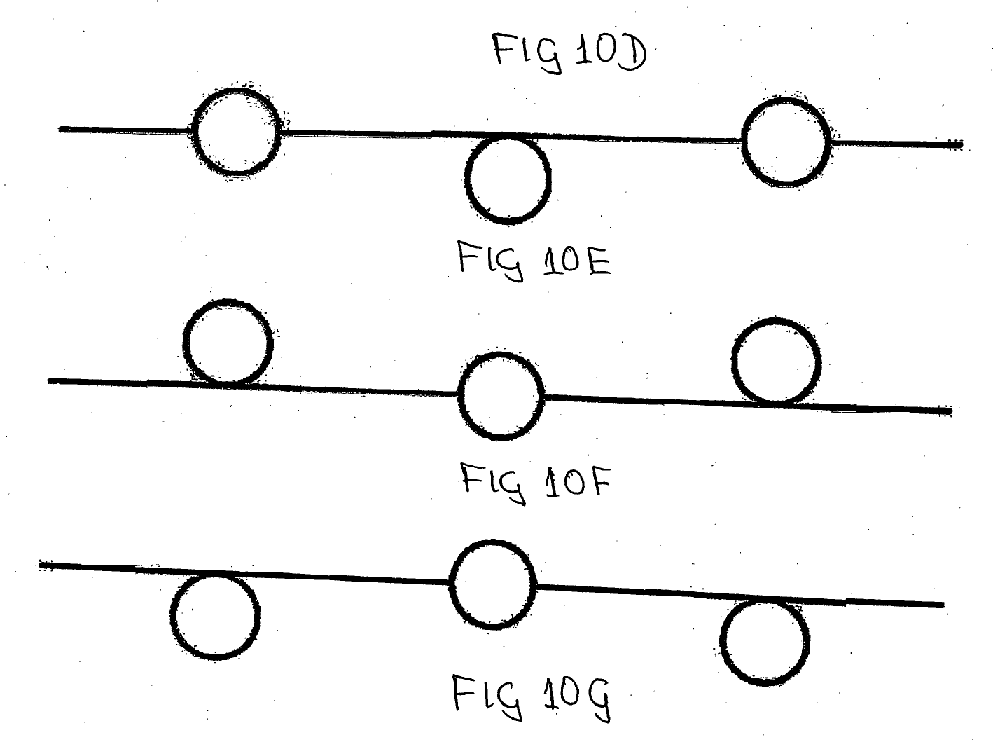

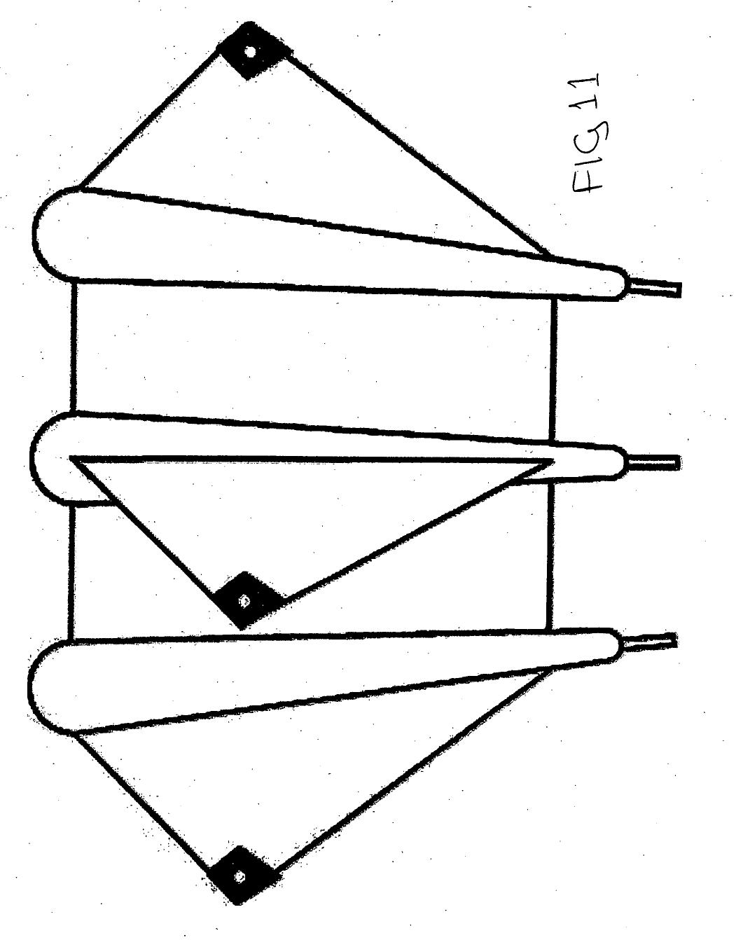

FIG. 10A and 10B show transverse sections (but without the central keel) of a kite of FIGS. 1 and 3 to show either above or in sheeting association or incorporation of the inflated beams. FIGS. 10C to 10G are the opposite of FIG. 10B (FIG. 10C) or are hybrids of FIGS. 1A and 1B.

FIG. 11 shows how for a two or more beamed kite (a three beam kite being shown) how all of the beams can taper off to the rear from a larger fore section. Whilst all beans are shown with a taper, and a constant taper at that, hybrids of varied tapering and/or no tapering are within the scope of the present invention.

Features Considered of Note

Longitudinal inflatable ribs.

Tapered shape.

Can optionally be made with multiple tow points on each keel to allow for greater or lesser pull in a variety of wind conditions.

Self launching from the water.

Bladder construction and valve.

Collapses if wind increases reforms and flies again when the wind drops.

Collapse point varies according to the diameter of the inflatable ribs and the distance they are apart from each other. Collapsing is beneficial as the kite can easily be recovered if the wind increases above what the flyer can safely manage or the kiteline can handle without breaking. It is safer for the kite and the operator.

The main cause of loss or damage to all other existing fishing kites is through overloading if the kite should go into the water. Either the kiteline will break or the kite will dive to the bottom and break spars or suffer serious scuffing as it is dragged in along the seabed. The inflatable kite floats high in the water and even if it fails to relaunch itself will come in easily on the surface. If it tries to dive it will collapse and the immediately resurface so it cannot be scuffed on the bottom and there are no solid spars to break.

Rib sizes can be made proportionately larger for weightless or lighter than air flight.

Can be flown off the wind (tacked) by shortening one of the outside bridle legs or optionally by placing a drogue or tail off centre at the bottom edge of the kite.

1. A kite having or including one or more membrane type panel(s) alone or collectively defining at least substantially all of the leading edge, trailing edge and the lateral expanse of the kite,
at least a keel from at or adjacent each lateral extremity, such a keel form being (directly or indirectly) each attachable to or attached to a control line or a bridle connecting or connectable to a control line, and
a fore and aft extending inflated or inflatable beam at or adjacent each lateral extremity and/or each keel form at or adjacent the lateral extremity.

2. A kite of claim 1 wherein each keel form is substantially in the form of a membrane so as to confine wind between the peripheral keels and the panel or panels.

3. A kite of claim 1 wherein the inflated or inflatable beams are tubular but can be of any inflated cross-section, and they can, if desired, taper or otherwise vary in cross-section along their length fore and aft.

4. A kite of claim 3 wherein the beam(s) on inflation assume along its (their) length an overall airfoil shape to assist lift.

5. A kite of claim 1 wherein the inflated or inflatable beams extend beyond the leading edge and/or trailing edge.

6. A kite of claim 1 wherein beams end flush with the leading and/or trailing edges.

7. A kite of claim 1 wherein the general longitudinal axis of each inflated beam is parallel to or angled acutely with respect to a central axis of the kite.

8. A kite of claim 7 wherein the angle with respect to the central axis is from 0 to 15 degrees (inclusive) with the beam to beam spacing being greater at the leading edge than at the trailing edge.

9. A kite of claim 8 wherein angles over 0 degrees are associated with a cross-sectional tapering of the beam(s).

10. A kite of claim 1 wherein the general longitudinal axis of each of said inflated or inflatable beams is such that there is an angling relative to a central axis of the kite or angling mutually with respect to each other.

11. A kite of claim 10 wherein said angling with respect to a central axis is less than 5 degrees and has the effect of providing a greater leading edge than trailing edge.

12. A kite of claim 11 wherein the angling is in the range of from 1 degree to 5 degrees with respect to a central axis.

13. A kite of claim 12 wherein said anglings is 2.5 to 3 degrees.

14. A kite of claim 1 having one or more additional inflated or inflatable beams that extend in or generally in a fore and aft direction.

15. A kite of claim 14 wherein such additional inflated booms are adjacent to an additional keel or other control line attachment apparatus.

16. A steerable single or multi-compartment, sled-shaped, inflatable kite having a pair or series of substantially longitudinal gas chambers as beams, which kite, when inflated, is generally in the form of a tapered rectangle with a triangular keel attached to each outside gas chambers (and optionally attached to each of any inside gas chambers), there being a non-inflatable area between the longitudinal gas chambers that provides sail area and/or additional sail area.

17. A kite of claim 16 wherein the two or the two outermost gas beams are set so that they are angled apart with the widest point at the top of the kite.

18. A kite of claim 16 wherein each keel has one or more line anchor points.

19. A kite of claim 18 wherein a bridle with as many lines as the kite has keels is tied to a common point sufficiently distant from the kite as to allow the kite to open correctly.

20. A kite of claim 16 wherein the kite has a minimum of two longitudinal gas beams and keels up to an unlimited number of longitudinal gas beams and/or keels, at least the two outside longitudinal gas beams having keels.

21. A kite of claim 16 wherein steering or tacking the kite may be achieved by shortening one of the outside bridle legs, putting a kite tail or drogue on one side or other of the kite, or both.

22. A tackable (steerable) single or multi-compartment, sled-shaped, inflatable kite having, when inflated, a series of longitudinal gas beams, each of which is attached to a keel.

23. A kite of claim 22 wherein two outside gas beams are set so that they are angled apart with the widest point at the top of the kite.

24. A kite of claim 22 wherein each keel has one or more in line anchor points.

25. A kite of claim 22 wherein bridle with as many lines as the kite has keels is tied to a common point sufficiently distant from the kite as to allow the kite to open correctly.

26. A kite of claim 22 wherein it has a minimum of two longitudinal gas beams and keels up to an unlimited number of longitudinal gas beams and keels, at least the two outside longitudinal gas beams having keels.
